(19) United States
(12) Patent Application Publication
(10) Pub. No.: US 2002/0178188 A1
(43) Pub. Date: Nov. 28, 2002

(54) Productivity recovery and improvement software

(76) Inventor: Jose A. Irizarry, P.E, Toa Alta, PR (US)

Correspondence Address: J MARK HOLLAND & ASSOCIATES, 3 CIVIC PLAZA SUITE 210, NEWPORT BEACH, CA, 92660

(21) Appl. No.: 09/866,117

(22) Filed: May 25, 2001

(51) Int. Cl. G06F 17/21

(52) U.S. Cl. 707/517; 707/503

(57) ABSTRACT

Apparatus and methods including a computer database to maintain a centralized and organized system of data related to work productivity. Systems of operation for various work facilities using the database are described. The database includes a number of modules to facilitate the ease of use and the usefulness of the database. The invention provides a number of tools including forms, reports, and tables to accurately and efficiently maintain updated records regarding work productivity. Multiple reports are provided to enable users to examine and determine and project potential and actual profitable and non-profitable areas within a business. The invention greatly improves productivity and reduces waste in running various businesses, including manufacturing and production plants.

### BACKGROUND OF THE INVENTION

This invention is generally directed to apparatus and methods for establishing, improving, and controlling productive work environments. More particularly, the invention is directed to a computer software system and related methods to readily organize and analyze work productivity data which provide complete, nearly instantaneous perspectives of productivity-related problems and future projections resulting from those problems. Among other things, the invention facilitates identifying potential areas for improving productivity and for resolving productivity problems.

Currently, it is common for industrial facilities or production plants such as pharmaceutical production plants to use manual methods and systems to record, process, and even analyze data relevant to work productivity. Some facilities do not even attempt to collect, let alone use, such data. Even when the manual systems are used, they typically have substantial limitations that can delay the availability of useful reports based on the data, can limit the potential useful scope and nature of those reports (such as not being able to anticipate potential problems and take action to prevent the problems from occurring or to be prepared to take remedial measures), and the like. The consequences can be unnecessary and wasteful spending and loss of valuable time, efforts, and other resources.

### OBJECTS AND ADVANTAGES OF THE INVENTION

It is, therefore, an object of the invention to provide an automated system that permits users to readily enter, document, and analyze data relevant to the productivity of such facilities or plants, thereby providing a tool to help directly improve the quality of the operation and output of the facilities and consequently their profitability.

The preferred embodiment of the invention provides an integrated software system for work-related productivity data and facilitates improved methods of doing business. It preferably includes a base software package that can have several different modules incorporated therein to provide numerous ways of entering, summarizing, analyzing, and presenting that data in graphical or other report formats. Within the preferred business method, this powerful computer tool can be used to improve profitability of a business and reduce unwanted expenses and lags in productivity. Although the invention is preferably used in industrial facilities, it can find equally valuable and beneficial uses in other work places, such as pilot plants and simulation facilities.

It is, therefore, an object of my invention to provide a computerized system and related method to quickly and easily store, organize, update, and report detailed information associated with productivity. The method includes, among other things, the steps of providing a sufficient number of data entry locations to facilitate prompt entry of productivity information; training personnel in gathering and inputting the information; establishing protocols and timetable goals for entry of the information in a timely manner, and periodically conducting quality control checks to determine whether those timetable goals are being met.

Another object of my invention is the provision of a business tool of the aforementioned character which can analyze and present the productivity data from a variety of different viewpoints.

It is a further object of my invention to provide a system as described herein which provides a user a complete or substantially complete perspective of a business's productivity in real time, and for use in future projections and forecasts. Among other things, prompt and ready entry of information of this type into the software of my invention can provide companies and organizations with the ability to more quickly and easily identify profitable and non-profitable areas, potential future problem areas that may reduce profits, etc.

By way of my invention, I also have invented a method for establishing and maintaining productive work environments, and improving the productivity thereof. My method preferably includes the steps of: performing and completing an assessment of a work place in order to determine problem areas and specific needs; restoring or establishing the necessary parameters for the work place to optimally perform; and developing for that work place a computerized software-based system as described herein that will help a company maintain and improve control of problematic areas.

As persons of ordinary skill in the art will appreciate, implementation of my software will preferably result in improved productive work environments; significant reductions in money (or other related resources such as man-hour and materials) wasteful practices; and improved productivity and profitability for the business. In addition, users will preferably acquire detailed information to establish logical and reasonable objectives and indicators for future improvement; focused root cause analysis, and operations behavioral tendencies.

Other objects and advantages of the invention will be apparent from the following specification and the accompanying drawings, which are for the purpose of illustration only.

### BRIEF DESCRIPTION OF THE DRAWINGS

FIG. 1 is a representative diagram of a preferred table component of a software database usable within the invention;

FIG. 2 depicts an example of various preferred relationships between tables of the invention;

FIG. 3 shows a preferred display for inputting various data into the invention;

FIGS. 4 and 5 illustrate exemplary graphical reports of data practiced with the invention;

FIGS. 6 and 7 show examples of some of the reports displaying data values;

FIG. 8 depicts an example of a preferred module of the invention's database, which provides navigation and access to various sub-modules; and

FIGS. 9-17 show some of the preferred sub-modules practiced with the preferred embodiment of the invention.

### DESCRIPTION OF PREFERRED EMBODIMENT

The preferred embodiment of the invention can be more fully appreciated by reference to the drawings and the following description. Where the same reference numbers appear in multiple figures, the numbers are normally intended to refer to the same or corresponding items in those figures.

In general terms, the preferred embodiment of my invention includes software operating on a conventional computer having a monitor, a processor, and at least one data input device such as a keyboard or a mouse. However, as further discussed herein, any suitable hardware or similar devices can be utilized.

As persons of ordinary skill in the art will understand, one of the important parts of the preferred embodiment of the invention is a computer database. In the preferred embodiment, database 10 is preferably built with, and operates in, Microsoft Access®; however, as persons of ordinary skill in the art will appreciate, any suitable database design software and operating system or environment can be used to practice the invention. By way of example, and not limitation, the invention can be practiced by utilizing Structured Query Language (SQL) databases and programming language code such as Visual Basic and Oracle.

Some of the basic relevant concepts (such as software relational databases and the like) are explained in further detail below and in connection with the drawings. Initially, however, it is helpful to understand some of the situations in which the invention is especially useful.

The invention is useful in a broad range of settings. By way of example and not by way of limitation, a preferred method of the invention can be practiced by starting with an overall assessment of a plant, a specific component of a production line, a sub-division of a larger business, or a small business. Preferably, a user reviews various business data, including man-hours, supply costs, material costs, utility costs, number of units produced per hour, per purchase, per employee, frequency of equipment failure, maintenance costs, etc. Other factors may also include employee efficiency, effect of efficiency by methods, materials involved in the process, equipment involved in the process, and overall environment. Based on those and possibly other factors, the user can utilize one or more of the various modules in the software database of my invention to track and analyze performance of their business or other organization. In implementing the system relevant to those selected criteria and modules, the user arranges for the entry of the various data and other information, either in real time or at some selected interval. Preferably, the user (or users) can also use the software to review “instant” reports and other business-related indices that are generated by the software of my invention.

The invention may be implemented in a dynamic setting, and may be installed and carried out on a business-wide, a plant-wide, or a division-wide scale, depending on the particular situation and the information desired and the system and criteria being monitored. In the preferred embodiment, this includes providing computer stations at appropriate locations (networked or otherwise in communication with each other and with a central database), training employees to operate the workstations, having employees routinely update/enter data at the various stations, having management and/or the workers periodically review the entered data, and making changes or modifications based in part on the data being tracked. By way of example and not by way of limitation, such changes might include performing more frequent maintenance if the number of units being produced decreases with total equipment run-time, or changing vendors if the cost of goods reduces profit margins or product quality. Preferably, my invention, and the information generated thereby, may also be used to forecast budget, adjust staffing level, and plan for capital investment, just to name a few.

In the preferred embodiment, the software database includes forms for input and other interaction with the user. The user preferably uses a data input device to select and activate the various controls provided on the forms. When a field (in the form) is provided to receive data, the user positions the computer cursor within the field and either manually enters the data or selects from values already provided (such as from a pull-down menu as may be provided in a list- or combo-box). The software can then check or otherwise validate the data to ensure that it complies with data entry rules or criteria. Once the data is entered, it preferably becomes readily, and nearly instantaneously, available to other users, for monitoring and improving work productivity.

In that regard, and as indicated above, the preferred embodiment of my invention can be configured to be operated either on a single computer, or on a network of computers. In such network settings, the data preferably can be entered and/or accessed readily from any of the networked computers. This can provide an easy and convenient method for individual employees to enter data into the database, and a method for administrators to access and analyze the data without having to gather and harmonize separately entered data.

To print paper copies of any of the various reports provided by my invention, a printing device is preferably operably connected to at least one of the computers running the database. Further in that regard, persons of ordinary skill in the art will understand that the valuable information gathered and presented by the invention can be communicated and utilized in a wide variety of embodiments, including e-mailed copies of output reports, faxed output directly from the database, wireless pagers or similar devices. Persons of ordinary skill in the art will understand that any suitable means can be used to transmit, communicate, or broadcast relevant information from the database in as prompt a manner as desired.

In the preferred embodiment, various security levels may be added to control and regulate data entry and access. Examples of security measures may include limited module access by specific user, read only access, read and data entry access, and delete access. As with other security measures, passwords may also be used for additional protection.

The invention provides a greatly improved method for improving or optimizing a work environment, including especially its productivity. Among other things, a preferred method of the invention includes steps of: examining a work area to evaluate factors that may decrease or hinder productivity; establishing parameters to improve the productivity of the work environment; and developing a computer database tracking application to effectively facilitate and manage the productivity of the work environment. Certain embodiments of the invention contemplate the customization of the software database (such as by tracking and reporting on specific parameters relevant to that installation) to meet the specific needs of a given situation or application of the invention.

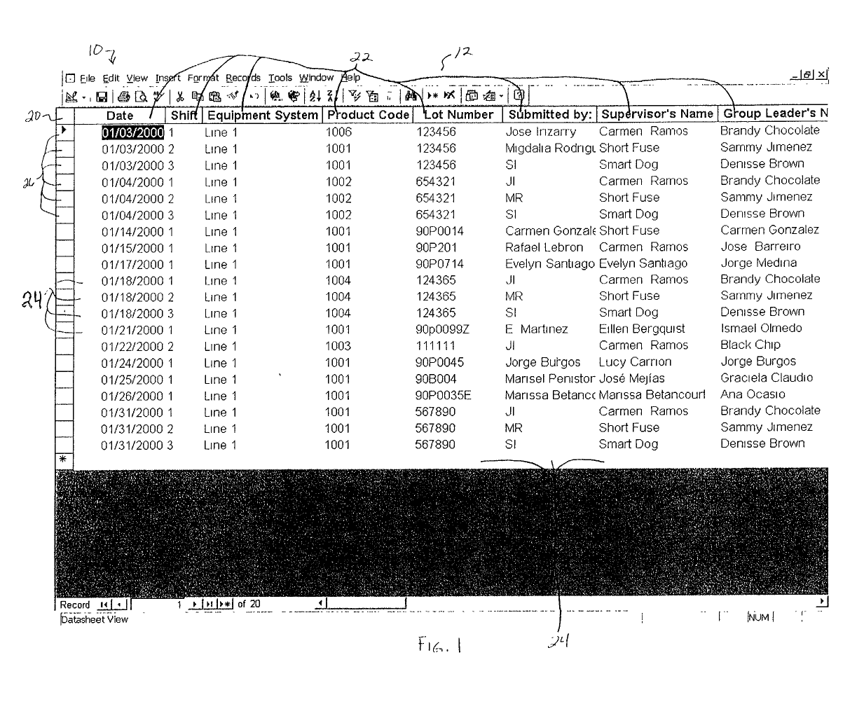

Referring to the drawings, and particularly to FIG. 1, part of a preferred database 10 is illustrated within a computer “window” or frame 12. Persons of ordinary skill in the art will understand that FIG. 1 and many of the other figures are shown as is conventionally practiced with current computer operating systems (such as Microsoft Windows®), although as noted above, any suitable software and hardware or operating system can be used, including Internet and web-based embodiments.

Similarly, persons of ordinary skill in the art will understand that, although the preferred embodiment is described as operating on conventional computers (such as personal computers having at least a central processing unit, a monitor or a device to display data of the computer, a keyboard, a mouse, or other means for inputting data and otherwise providing instructions for the computer), any suitable hardware can be utilized. By way of example and not by way of limitation, in many applications it will be beneficial to utilize touchscreen, palm computers, laptops, bar-coding, wireless communications, voice-recognition software, and similar technology to efficiently and promptly gather and input relevant information into the database (or for eventual downloading and use within the database).

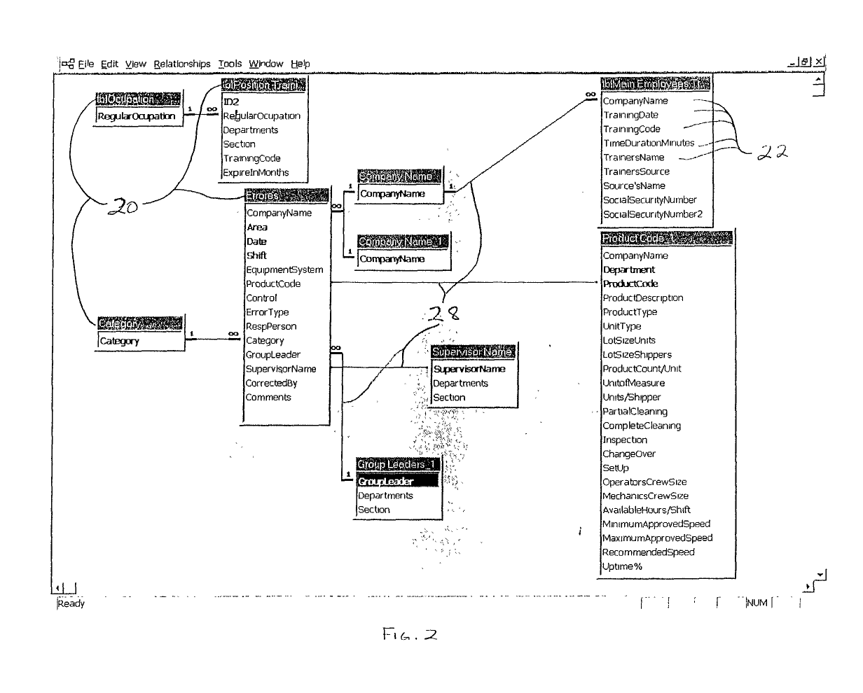

In its preferred embodiment, database 10 includes a plurality of tables 20 each having at least one field or category 22 to classify, segregate, or otherwise organize data stored within the database. In the preferred embodiment of the invention, tables 20 can be linked to each other by fields 22 that are related or similar (see FIG. 2). Also, data may be stored in a “perpetual” fashion depending on the system's storage capacity, security control, and desirability of managerial staff.

Among other things, relationships 28 provide improved database performance. For example, relationships can efficiently create and maintain uniformity of information or data within the database, which can be helpful in entering, analyzing, and presenting data stored therein. In the preferred embodiment, and among other things, these relationships provide a way of validating and controlling data that is input into the database. Moreover, as may be understood within database programming, the type of data entered into any particular field can be controlled by properties that do not permit records to be added or changed, and instead, provide the option to select a value from a list of entries. However, it is also conceivable to permit users to select data from the list or add records thereto.

Examples of types of relationships provided within the invention include: one-to-one; one-to-many; many-to-one; and many-to-many relationships. Among the many other benefits of using a relational database in practicing the invention, it is possible to update all records associated with a particular value which can greatly facilitate and improve the usability of the data.

Although it is preferable to provide multiple tables 20 as discussed above, it is conceivable and within the scope of the invention to also provide a single table 20 containing all of the desired fields 22 needed to organize and utilize the data.

As illustrated in FIG. 1, table 20 includes at least one field 22 to organize data. Table 20 also includes at least one record 26 of relevant data. Persons of ordinary skill in the art will understand that, as is conventionally practiced in databases, data for a particular entry are stored within an individual record, and are segregated or organized by field. In that regard, field titles or names can be provided to facilitate proper organization of data among the fields. Furthermore, in the graphical presentation of FIG. 1, the intersection of any particular record with a particular field is referred to as a cell, such as depicted as cells 24. The cells 24 at the bottom of FIG. 1 are for a new record that may be entered.

As discussed above, and as illustrated in FIG. 1, the database is directed to a device or system for storing and analyzing data relevant to work productivity. Thus, the preferred embodiment of database 10 contains a plurality of fields 22 to store data relevant to work- or job-related productivity and performance. The preferred embodiment of the invention includes a sufficient number of fields 22 to provide a comprehensive analysis of information related to work productivity and performance. By way of example, and not limitation, and as illustrated in FIG. 1, fields can be designated for data including the organization or plant name, shift, equipment system, product code, lot number, report date, reporting person, supervisor's name, and other related categories.

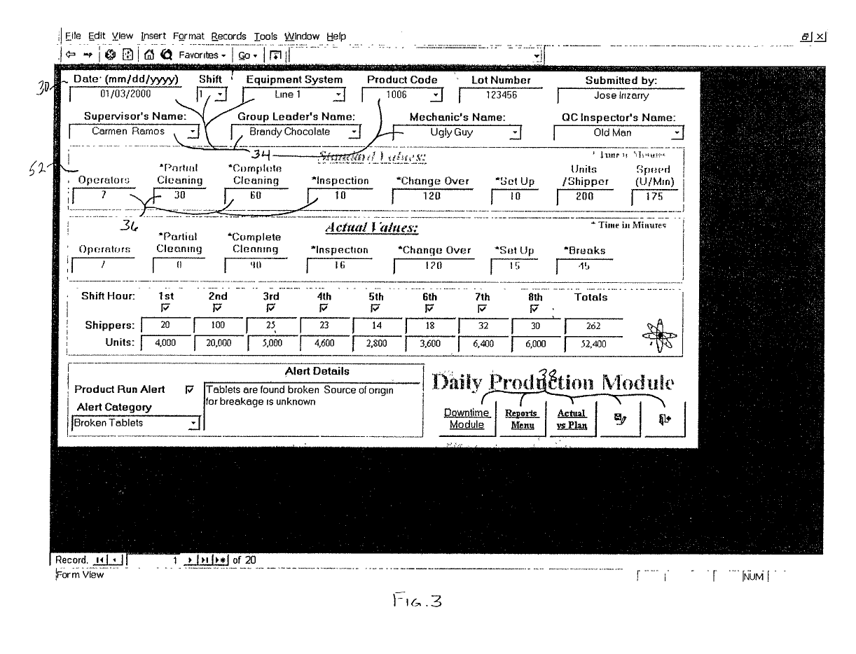

FIG. 3 illustrates the use of a form 30 to facilitate the ease of using and entering information or data into the database. Persons of ordinary skill in the art will understand that virtually limitless kinds and layouts of forms can be utilized with the invention, and are preferably created and configured to enhance the speed and ease of entry of relevant information. In that regard, forms are preferably designed to provide an efficient method of entering data related to a common subject. Moreover, alternative embodiments of the invention could be practiced by designing forms that use multiple pages or tab structures to improve the usability of the invention. Fields 34 can be of various types to control the accuracy of data input. In that regard, some types of fields could include text boxes; list boxes; or combo boxes. In addition, the fields 34 can be configured to permit data entry or to calculate and return values based on other information input into other fields. Relatedly, fields 36 that are configured to display data, but not to have data manually input into them can also be provided.

A number of controls or switches 38 are preferably provided on form 30 to improve the use of the invention. As illustrated, some of the actions of controls 38 include opening another form; searching the database; accessing reports as discussed herein; saving a record; or closing the form. Furthermore, controls could be provided to process a set of instructions to perform relatively more complicated tasks.

As persons of ordinary skill in the art will appreciate, the provision and use of forms 30 not only facilitates control and customization of the way data is entered into and displayed by the invention, it also provides a method of validating and controlling that input data.

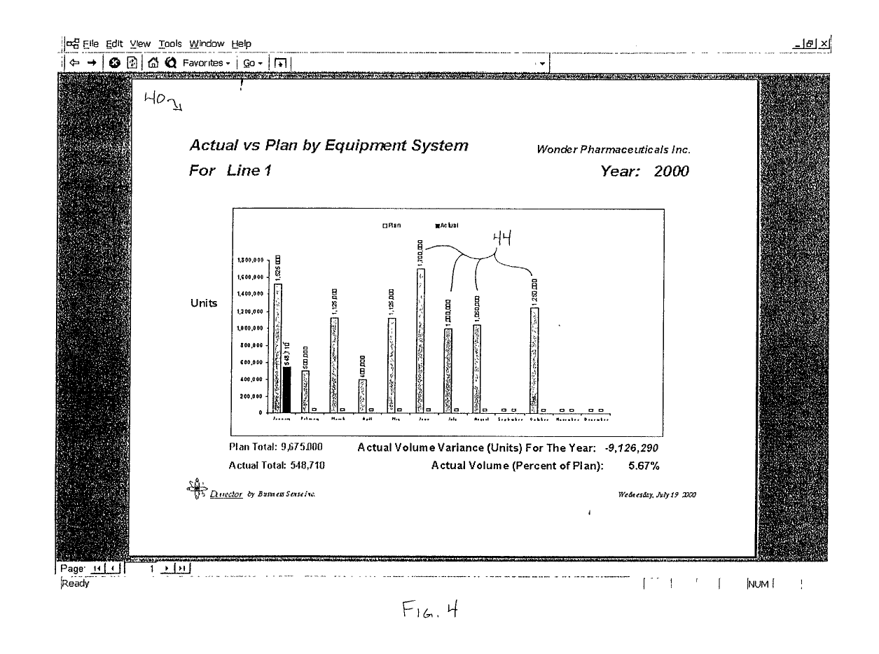

FIGS. 4-7 illustrate some of the many possible ways of displaying the data stored in database 10. As can be appreciated by persons of ordinary skill in the art, any appropriate or helpful number or arrangement of displays or reports 40 can be prepared in order to facilitate the analysis of the data. Reports 40 can present data in textual/numeric, graphical, and other formats to facilitate complete analysis of productivity information. This can provide a tremendous benefit to users of the invention, and the inventor is not aware of this functionality and benefit existing prior to the instant invention. Among other things, reports as illustrated and provided by the invention can greatly facilitate instantaneous assessment of work or plant productivity as well as predicting future projections resulting from performance. Current systems of which the inventor is aware result in the delay of daily production and downtime information, do not permit immediate predictions for future performance, and delays the opportunities for investigation of errors.

In addition, the preferred embodiment of the invention also provides ways for maintaining up-to-date, accurate reports that may be desired or required by particular organizations. In the preferred embodiment, the software can provide “automatic” update checking (such as by automatically prompting the user to permit the software to check the status of various report forms over computer networks such as the Internet, and determine whether the software is using the most current forms/reports). Among the many alternatives, updated forms and reports can be readily distributed to owners of the software (by the original seller of the software).

Persons of ordinary skill in the art will also understand that the preferred embodiment of the invention permits multiple users to simultaneously access and use the software and data therein. For example, managers at international and/or national headquarters might have “real-time” reports that incorporate information input just seconds earlier by any number of workers in remote locations. This can improve the quality of business decisions at all levels. Even if all data is not incorporated into a master database in “real time”, it can be conveniently input and recorded in remote copies of the preferred database for subsequent and easy synchronization into that master database. Alternatively or additionally, some or all of the data can be entered “after the fact” rather than in “real time”, although the “real time” benefits and usefulness of the invention will be correspondingly compromised.

Network capabilities of the invention help monitor any incidents or other productivity issues at job sites with employers/managers who may be off-site. One way of assuring that assignments or tasks are timely conducted or completed is by allowing managers to view the status of the assignments for individual employees. As can readily be appreciated, employees typically do not want to develop negative exposure to their superiors, and therefore, will be motivated to complete and otherwise perform their designated assignment.

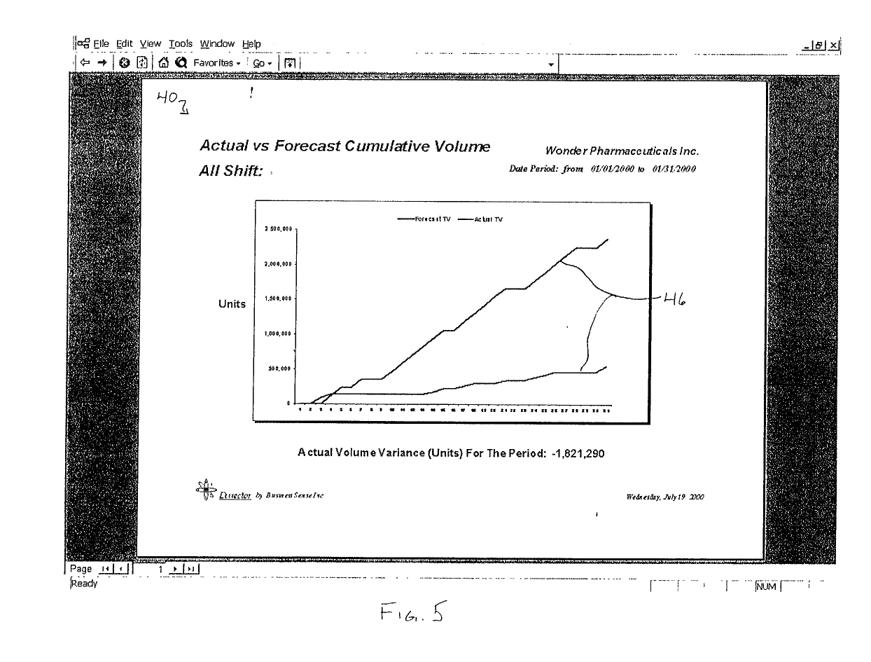

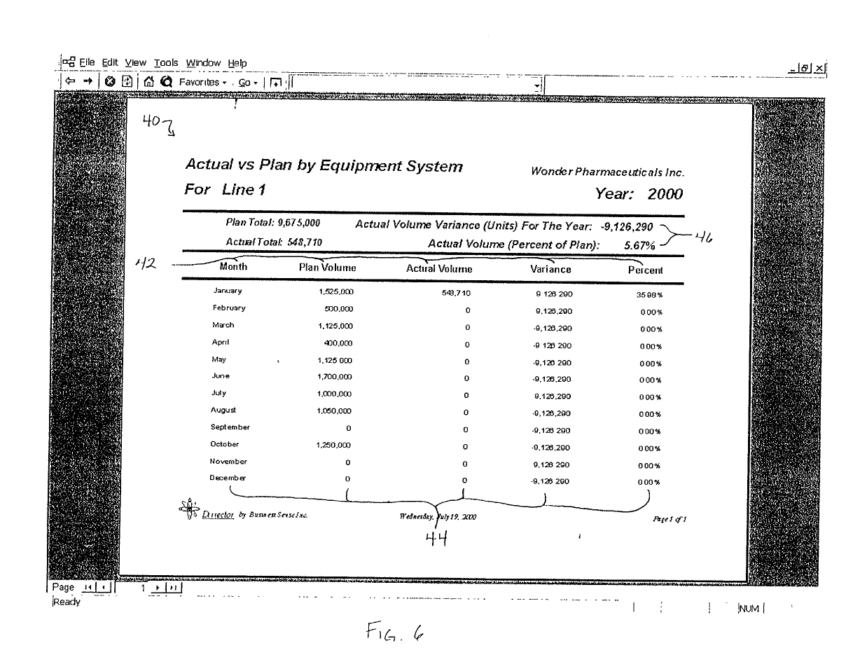

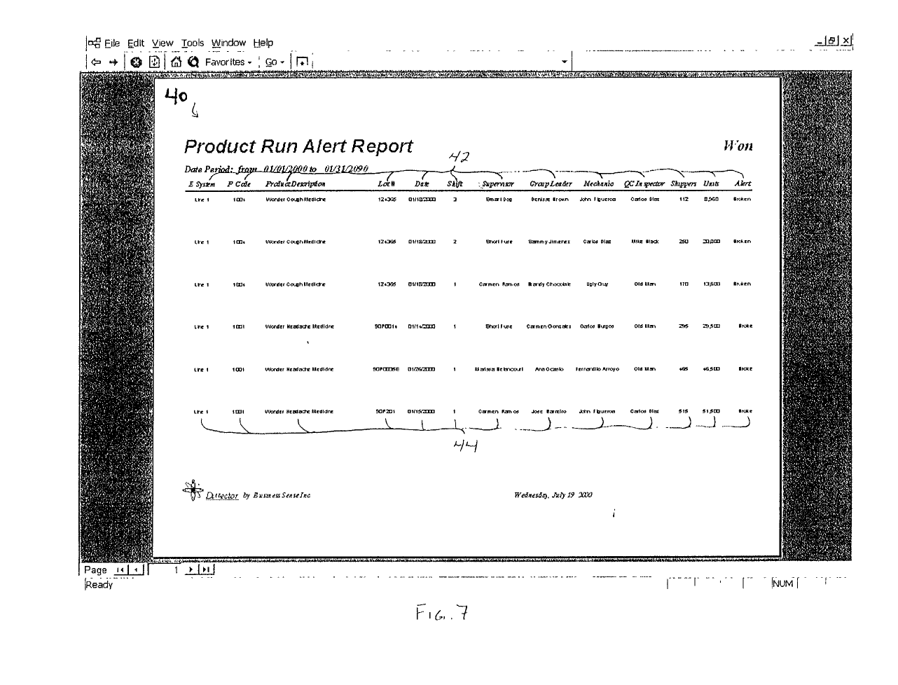

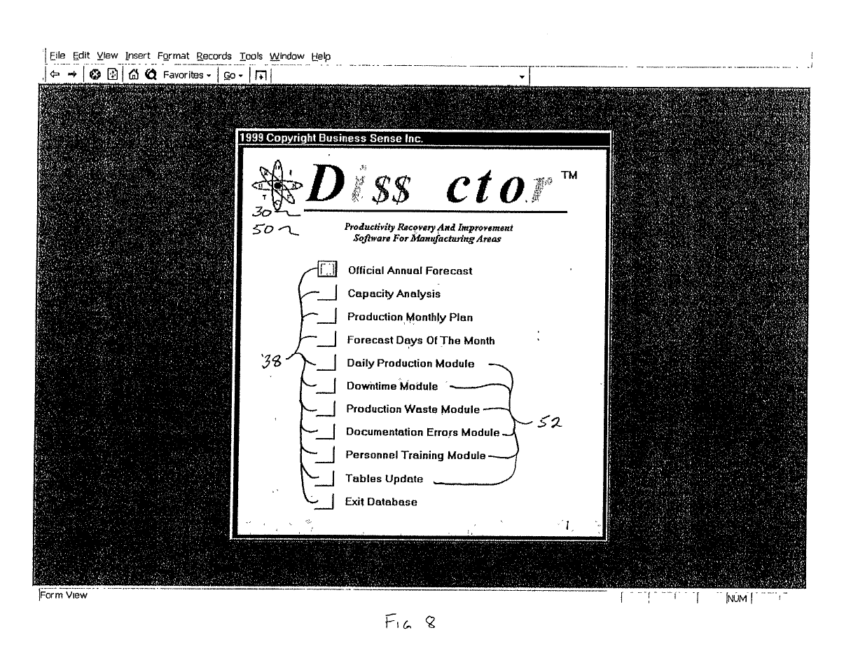

With reference to FIGS. 4-7, reports 40 are preferably designed to display data or data values 44 preferably in a logical and comprehensible format to facilitate analysis, comprehension, and use of same. In that regard, and as shown in FIGS. 6 and 7, report fields 42, potentially corresponding to fields 22 or 32 discussed above, can be presented to visually segregate related data values 44. In addition, the reports can include calculated data values 46 and numerically (FIGS. 6 and 7) or graphically (FIGS. 4 and 5) display those values.

Reports 40 can also include additional information to facilitate the organization and understanding of the reports. That information can include report titles, page numbers, dates, organization information such as company name, or other textual information as may be needed or desired.

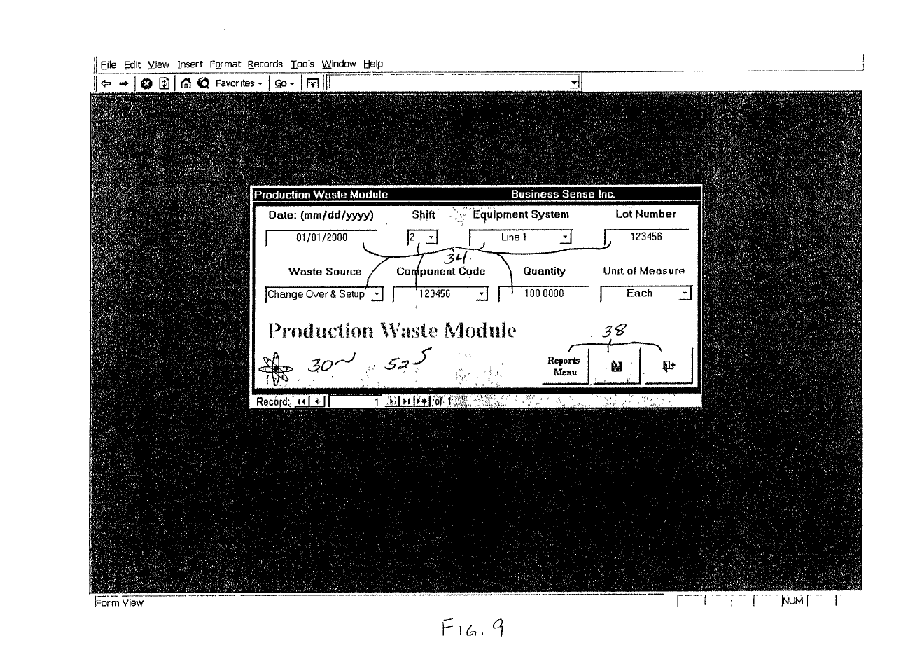

In addition to the foregoing functions of database 10, a number of modules 50 (see FIGS. 9-16) can be provided within the database to improve customization and usability of the database. Much of this related data provides substantial utility and benefits to persons and companies practicing and using the invention. For example, integrating training and “action” items in a software database that includes productivity data permits prompt and efficient tracking, planning, organization, and focus of corrective efforts in a way that is vastly superior to paper-based systems or even electronic systems that may use spreadsheets. As mentioned above, the improved speed and depth of analysis provided by the system can be of tremendous value.

For example, with reference to FIGS. 4 and 5, by providing numerous ways of summarizing and presenting data, it is possible to identify and examine patterns or tendencies within the data that will assist in the development and implementation of reliable, permanent solutions to solve problems. In conventional, existing systems, obtaining and preparing such analyses may not be possible to the degree provided by the preferred embodiment or alternative embodiments of the invention, and in any case requires substantial, detailed, and time-intensive coordination of many people, computers, software programs, and/or supplies or other materials and resources. In contrast, the preferred embodiment of the invention brings together what are conventionally numerous separate productivity protocols and procedures (and some protocols that may not be practiced at all in many or most locations) into a single, integrated system. Much of this benefit derives from the various modules discussed herein, and persons of ordinary skill in the art will understand that further modules can be added (and not all of the modules described herein need be used) in practicing the invention.

As can also be appreciated, conventional systems and the analyses performed therewith are typically more dependent on the quality of training of individuals involved than is the case with the preferred embodiment of the invention.

An example of a preferred module 50 to use with the software is related to productivity recovery and improvement. The module can include sub-modules 52 related to: daily production; production waste; personnel training; documentation errors; official annual forecasts; capacity analysis; downtime; production monthly plans; and forecast days of the month. Additional sub-modules provided can provide convenient methods of updating tables and/or user and group accounts.

Similar to the discussion above, modules 50 are preferably designed as forms 30 having controls or switches 38 to perform the requested or desired instructions.

Referring back to FIG. 3, a preferred daily production sub-module 52 is illustrated. Preferably and generally, daily production sub-module 52 permits a user to record any detailed information related to production performance by line, shift, product, lot number, supervisor, group leader, and mechanic. This module will provide the ability to list any abnormal situation flagged in the product run alert window, and determines and/or revises production standards by product, line, and shift.

FIG. 9 illustrates a preferred production waste module wherein a user can enter and track information, including statistics, related to production waste by line, shift, product, lot number, supervisor, group leader, and mechanic. It also permits revisions of packaging waste standards by product and individual packaging component.

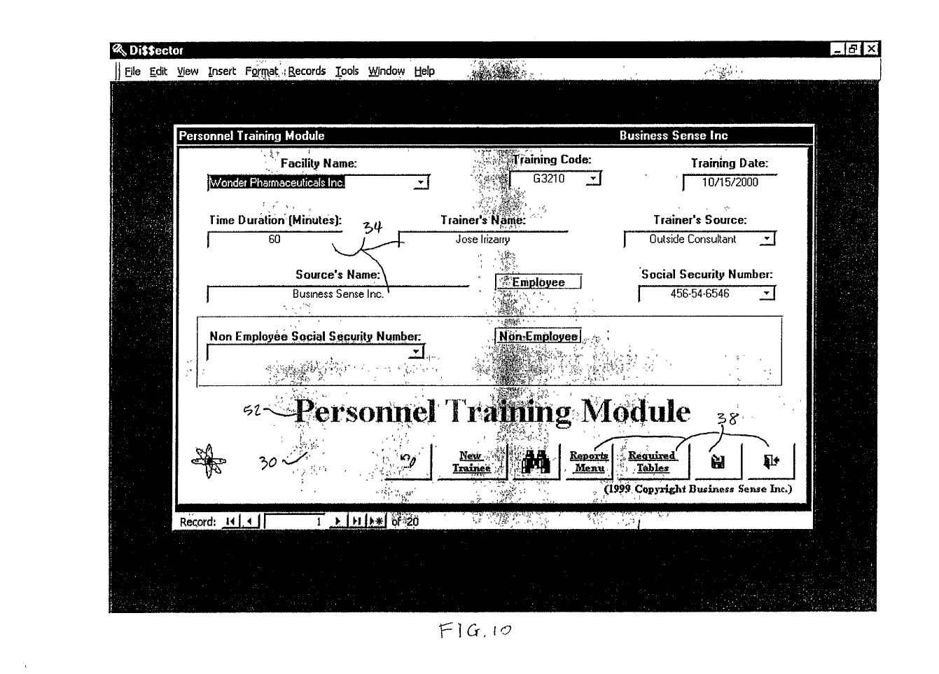

FIG. 10 depicts a preferred personnel or employee training module to record all training activities offered to each employee, as well as department meetings presented by facility and/or hired trainers. The information preferably accounts for total employees as well as training attendance, to facilitate calculation of attendance rate. Reports for this module can preferably present training information by employee, training name, training category, department, training schedule, training due for each employee and/or department, and reports for non-employees working at the work site.

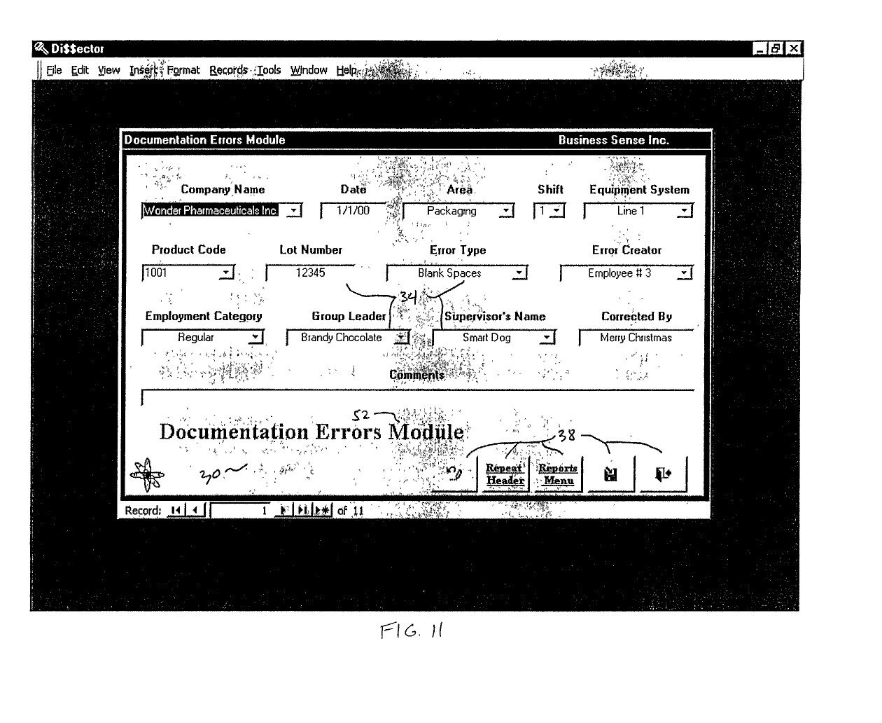

In FIG. 11, a preferred documentation errors module is shown. This module preferably complements the other modules and can preferably monitor and control documentation errors at any stage of a process. It is also capable of producing statistics over time including errors by area, employee category, lot number, type, group leader, equipment system, product code, error creator, shift, and supervisor.

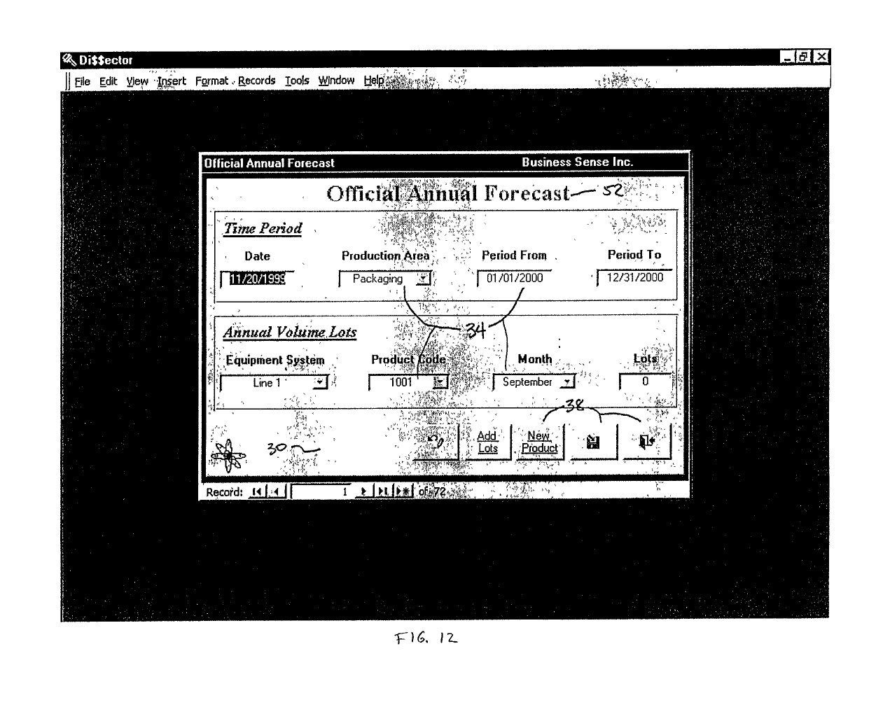

A production forecast, or official annual forecast module is shown in FIG. 12. This module preferably allows a user to input an organization's annual forecast and edit the information as needed. By combining the production daily information with the forecast information the user will be able to determine production attainment to plan by equipment system and shift, for example.

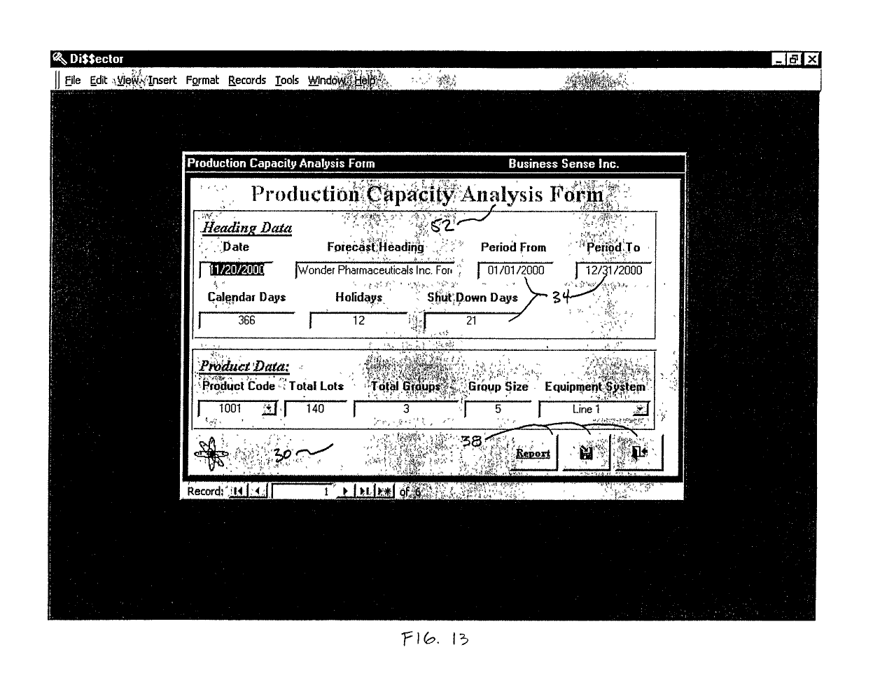

FIG. 13 illustrates a preferred capacity analysis module to help determine system and/or line production hours and total man-hours for any given forecast scenario that may include product mix, volume, time period, downtime percent, product standards, consecutive lots logistics, and crew size.

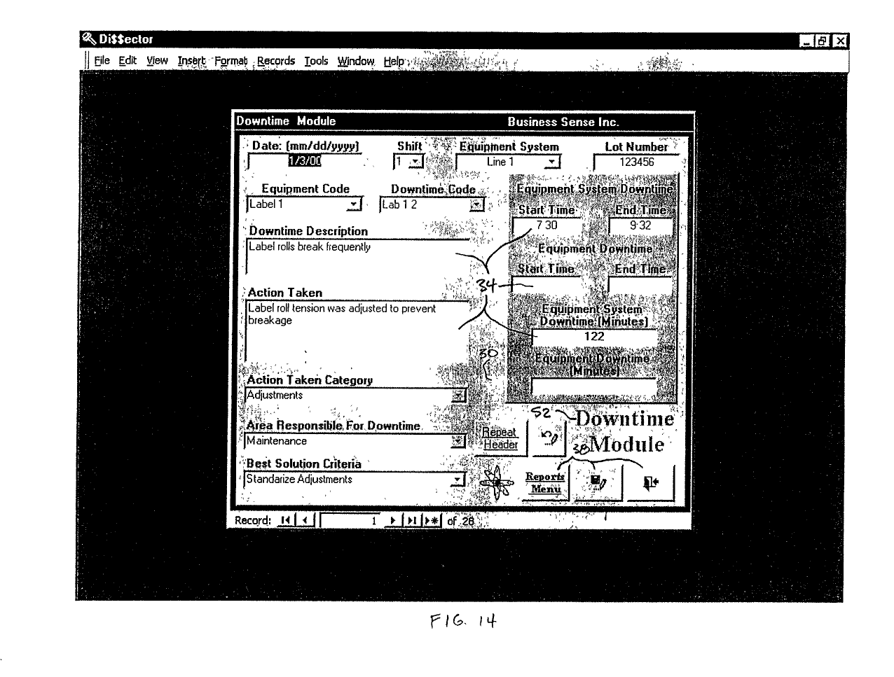

The preferred downtime module illustrated in FIG. 14, can determine downtime statistics, such as Pareto Analysis, by variables including: line, shift, product, equipment, downtime code, mechanic, downtime associated area, and downtime root cause. The module can preferably revise downtime and line clearance standards by product, equipment system, and shift, among other things.

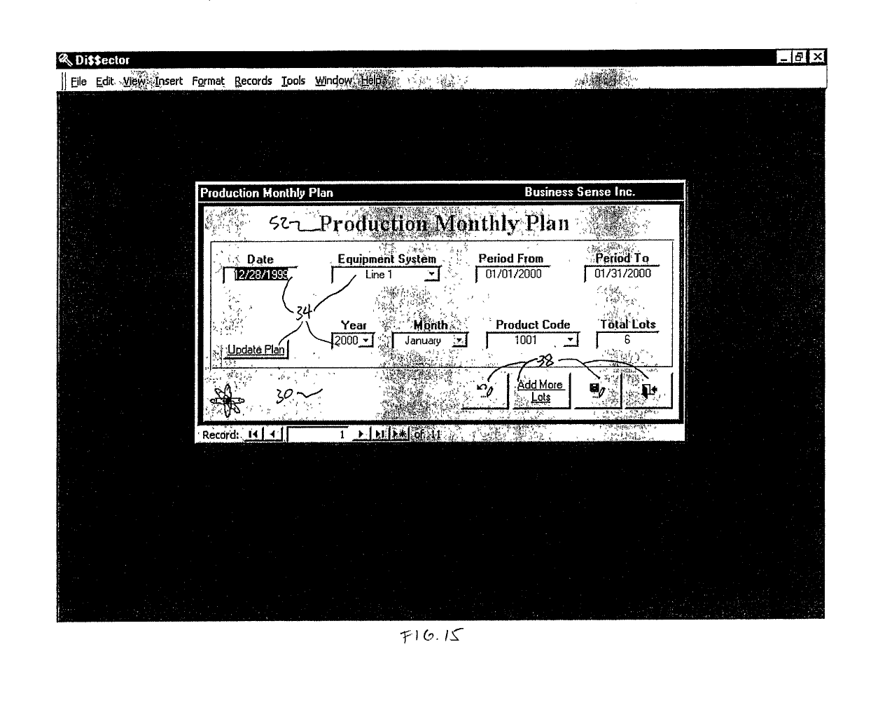

FIG. 15 depicts a preferred production monthly plan module practiced with the invention. Among other things, this module permits a user to enter and update data related to production goals. Data can be related to equipment system, forecast period, equipment code, and number of lots.

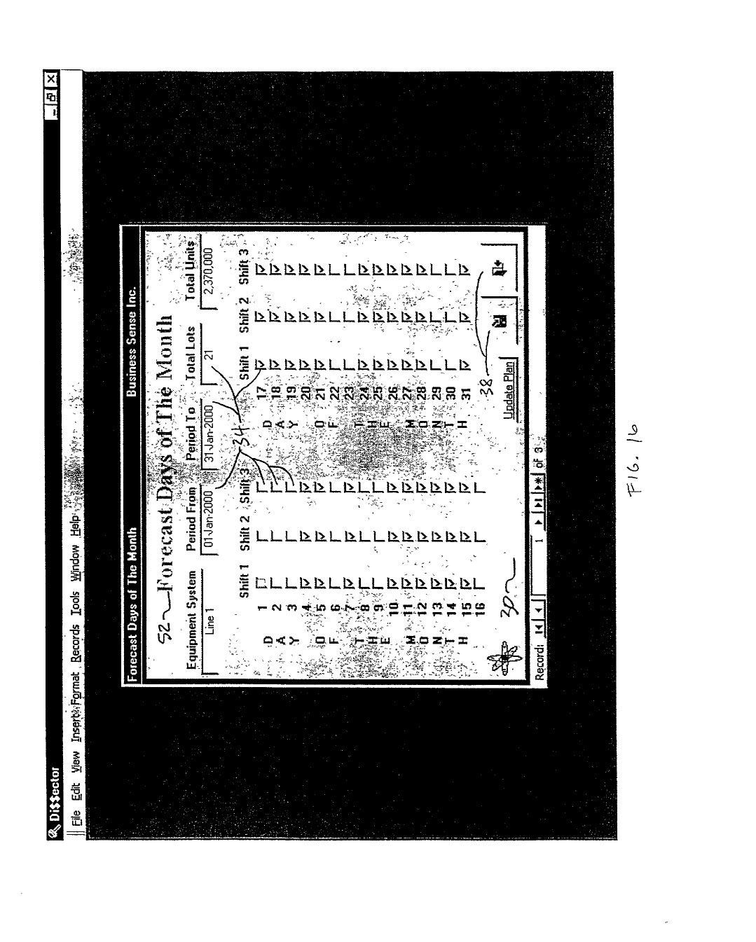

A preferred embodiment of a forecast module, named forecast days of the month module, is illustrated in FIG. 16. This forecast module enables a user to specify forecast information related to work productivity and to analyze the information by time period, equipment system, number of lots, number of units, days of the month, and work shift. As discussed herein, this module is preferably interrelated with other modules to complement the other modules' analysis and presentation of data.

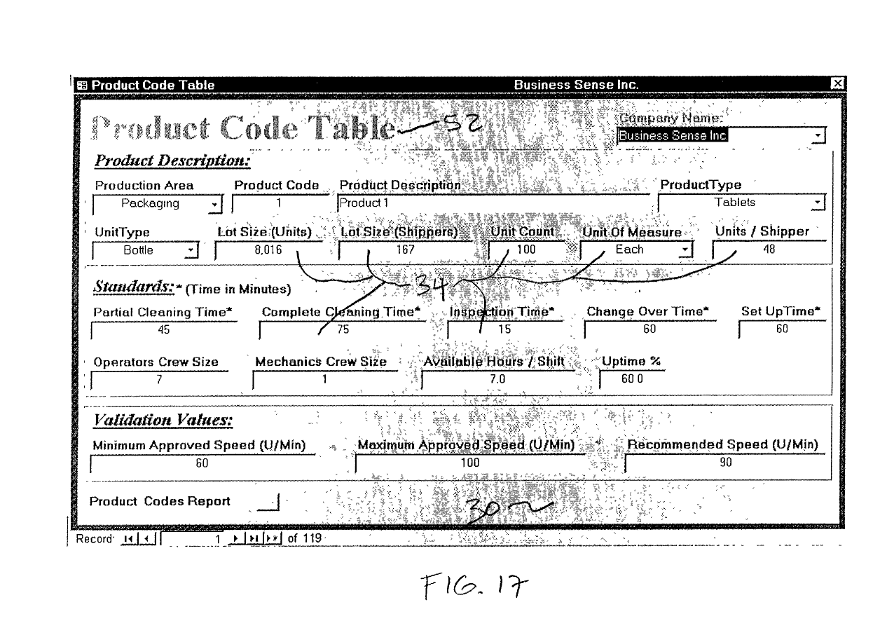

FIG. 17. depicts a product standards module and permits computation and/or updating of product standards using daily production information available for any given product or for an entire product composition.

The apparatus and methods of my invention have been described with some particularity, but the specific designs, constructions and steps disclosed are not to be taken as delimiting of the invention. Obvious modifications will make themselves apparent to those of ordinary skill in the art, all of which will not depart from the essence of the invention and all such changes and modifications are intended to be encompassed within the appended claims.

I claim:

1. A computer application to organize and monitor work related productivity information, including: a database to store data relevant to work related productivity, said database providing for data entry and data presentation, and configured to nearly instantaneously display said data in at least one format.

2. The computer application of claim 1 wherein said database is configured to nearly instantaneously display said data in multiple selectable formats, said multiple formats including graphical or textual viewpoints.

3. The computer application of claim 1 wherein said computer application is programmed for use in manufacturing and packaging facilities.

4. The computer application of claim 1 including at least one module related to manufacturing or packaging forecast, capacity analysis, monthly plan, production related results, downtime details, production waste details, documentation errors, or personnel training.

5. The computer application of claim 4 in which more than one such module is provided and those modules are interrelated.

6. The computer application of claim 1 in which said data is stored in a perpetual record.

7. A computer database for maintaining job-related productivity data, including: at least one table for storing said productivity data; at least one form for entering said productivity data; and at least one report for displaying said productivity data.

8. The computer database of claim 7 including at least one module, said at least one module related to a category of said productivity data.

9. A method of improving productivity in a work environment, including the steps of:
a) examining a work area to evaluate factors decreasing said productivity;
b) establishing parameters to improve said productivity of said work environment; and
c) providing a computer database application to track said parameters and to provide reports regarding same.

10. The method of claim 9 in which said computer application is customized for said work environment.

11. The method of claim 9 in which said work environment includes an industrial facility.

12. The method of claim 9 in which said computer application provides a centralized system for organizing and analyzing work-related data.

13. A method of improving performance and productivity in a work area, including the steps of:
a) providing at least one computer database to store information regarding the work area's productivity and performance;
b) inputting said information into said at least one database;
c) displaying said information in at least one format, said at least one format permitting analysis of said information; and
d) optimizing at least one aspect of said work area based on said analysis of said information.

14. The method of claim 13 wherein said information is related to other information facilitating said analysis of said information.

15. The method of claim 13 in which said analysis of said information can be conducted nearly immediately after said information regarding the work area's productivity and performance is input into said at least one computer database.

16. The method of claim 13 in which said implemented system facilitates said work area's compliance with production and training goals as those goals may change over time.

17. A multi-user computer database for maintaining job-related productivity data, consisting of: at least one table for storing said productivity data; at least one form for entering said productivity data; and at least one report for displaying said productivity data.

18. The computer database of claim 17 including at least one module, said at least one module related to a category of said productivity data.

19. The computer database of claim 18 in which said data is stored in a perpetual record.

20. A computer database for storing work productivity information, consisting of: a plurality of tables for storing a manufacturing plant's productivity information; a plurality of forms for entering and displaying said manufacturing plant's productivity information; and a plurality of reports for displaying said information.

21. Software for enhancing various job-related indices, said software configured to include an entry screen for entering job-related data, said entry screen including one or more fields for accepting entries and said job-related data including overhead and production data, a database for storing said job-related data, an algorithm for manipulating said entered data, and at least one module for presenting said manipulated data in a job-related indices format, said format including at least one of downtime details, monthly planning, and production forecast.

22. A business analytical software for improving business efficiency, said software including at least one form, at least one module, multiple input fields, a database, and algorithm for manipulating input data and displaying said manipulated data in a business related format, said format including at least one format from the group of expense details, income details, and monthly planning, said input data including data representative of business efficiency.

23. The software of claim 21 or 22, further including programmable options for instantaneously presenting information in past, present, or future projection format, said format including at least one of Pareto Analysis and performance target analysis.

24. A method of improving performance and productivity in a work area, including the steps of:
providing a multi-user computer database to store information regarding the work area's productivity and performance;
providing a sufficient number of data entry locations to facilitate prompt entry of productivity information;
training personnel in gathering and inputting the information.

25. The method of claim 24, further including the step of:
establishing protocols for entry of the information in a timely manner.

26. The method of claim 24 or claim 25, further including the steps of:
establishing timetable goals for utilization of the database; and
periodically conducting quality control checks to determine whether those timetable goals are being met

27. The method of claim 24, including the further step of using the software to track data and generate reports regarding at least one of daily production, production waste, personnel training, documentation errors, official annual forecasts, capacity analysis, downtime, production monthly plans, and forecast by day and by shift.

28. The method of claim 24, including the further step of using the software to track data and generate reports regarding production waste by line, shift, product, lot number, supervisor, group leader, or mechanic.

29. The method of claim 24, including the further step of using the software to track data and generate reports regarding revisions of packaging waste standards by product and individual packaging component

30. The method of claim 24, including the further step of using the software to track data and generate reports regarding training scheduled and completed by employees or personnel.

31. The method of claim 30, including the further step of using the software to track data and selectively generate reports presenting training information by employee, training name, training category, department, training schedule, training due for each employee and/or department, and for non-employees working at the work site.

32. The method of claim 24, including the further step of using the software to track data and generate reports regarding capacity analysis to determine system and/or line production hours and total man-hours for any given forecast scenario, including at least one of product mix, volume, time period, downtime percent, product standards, consecutive lots logistics, and crew size.

33. The method of claim 24, including the further step of using the software to track data and generate reports regarding capacity analysis to determine system and/or line production hours and total man-hours for any given forecast scenario, including at least one of product mix, volume, time period, downtime percent, product standards, consecutive lots logistics, and crew size.

34. The method of claim 24, including the further step of using the software to track data and generate reports regarding statistics over time including errors by area, employee category, lot number, type, group leader, equipment system, product code, error creator, shift, and supervisor.
